(19) United States
(12) Patent Application Publication
(10) Pub. No.: US 2008/0113102 A1
(43) Pub. Date: May 15, 2008

(54) Agents for the surface treatment of zinc or zinc alloy products

(76) Inventors: Takashi Arai, Tokyo (JP); Ro Bo Shin, Tokyo (JP); Takahisa Yamamoto, Ebina City (JP)

Correspondence Address: GRAY, PLANT, MOOTY, MOOTY & BENNETT, P.A., P.O. BOX 2906, MINNEAPOLIS, MN, 55402-0906, US

(21) Appl. No.: 11/598,454

(22) Filed: Nov. 13, 2006

(51) Int. Cl. B05D 1/18; C01G 19/00; C01G 29/00; C01G 30/00; C01B 19/00; C07F 9/90; C07F 9/94; C07F 9/92

(52) U.S. Cl. 427/436; 252/389.54; 252/389.1; 252/387; 423/494; 423/491; 423/489; 423/289; 423/395; 423/508; 423/419.1; 423/544; 423/561.1; 423/473; 423/617; 423/618; 556/78; 556/79; 556/76

(57) ABSTRACT

Agents for surface treatment which can impart excellent corrosion resistance to zinc or zinc alloy products at low cost. The agents for the surface treatment of zinc or zinc alloy products of this invention include at least one water-soluble compound which contains antimony, bismuth, tellurium or tin. Ideally, a nickel salt and/or a manganese salt is also included, and most desirably tannins and/or thioureas are also included. Ideally, the zinc or zinc alloy products which have been immersed and treated in an aqueous solution which contains these agents for surface treatment are immersed in an aqueous solution which includes a sealing treatment agent selected according to the colour of the zinc or zinc alloy product to seal pinholes.

### FIELD OF THE INVENTION

The invention concerns agents for the surface treatment of zinc or zinc alloy products and a method for the surface treatment of zinc or zinc alloy products in which these agents are used.

### BACKGROUND TO THE INVENTION

In the past zinc die-cast products, or zinc plated products where zinc has been plated on steel or the like, have been used in various fields. Chromate treatments have been widely used as surface treatments for imparting corrosion resistance to these products, but replacement methods have been investigated from various points of view since hexavalent chromium is toxic. However, there are great expectations of a method of surface treatment which is equivalent to chromate treatment in terms of low cost and corrosion resistance.

Hence the inventors have carried out various investigations with a view to obtaining an agent for the surface treatment of zinc or zinc alloy products which provides excellent corrosion resistance at low cost and the present invention has been realized.

### SUMMARY OF THE INVENTION

The present invention provides the inventions indicated below for resolving the abovementioned problems.

(1) An agent for the surface treatment of zinc or zinc alloy products which is characterized in that it includes at least one water-soluble compound which contains antimony, bismuth, tellurium or tin.

(2) An agent for the surface treatment of zinc or zinc alloy products which is characterized in that it includes at least one water-soluble compound which contains antimony, bismuth, tellurium or tin, and a nickel salt and/or a manganese salt.

(3) An agent for the surface treatment of zinc or zinc alloy products which is characterized in that it includes at least one water-soluble compound which contains antimony, bismuth, tellurium or tin, a nickel salt and/or a manganese salt, and tannins and/or thioureas.

(4) An agent for the surface treatment of zinc or zinc alloy products according to (2) or (3) above in which the nickel and manganese salts are selected from among the sulphates, chlorides, nitrates and phosphates.

(5) An agent for the surface treatment of zinc or zinc alloy products according to any of (1) to (4) above which also includes inorganic additives selected from among the inorganic acids and iodine compounds.

(6) An agent for the surface treatment of zinc or zinc alloy products according to any of (1) to (5) above which also includes organic additives selected from among the amino acids, starch, cellulose, gelatin, rosin and poly(vinyl alcohol).

(7) A method for the surface treatment of zinc or zinc alloy products which is characterized in that a zinc or zinc alloy product is immersed in an aqueous solution which contains an agent for the surface treatment of zinc or zinc alloy products as disclosed in any of (1) to (6) above.

(8) A method for the surface treatment of zinc or zinc alloy products according to (7) above which is characterized in that the zinc or zinc alloy product is also immersed in an aqueous solution which contains a sealing treatment agent.

(9) A method for the surface treatment of zinc or zinc alloy products according to (8) above in which the sealing treatment agent is selected according to the colour of the zinc or zinc alloy product.

Zinc or zinc alloy products can be provided with excellent corrosion resistance at low cost by means of this invention.

An agent for the surface treatment of zinc or zinc alloy products of this invention includes at least one water-soluble compound which contains antimony, bismuth, tellurium or tin. Ideally it also includes nickel salts and/or manganese salts, and most desirably it also includes tannins and/or thioureas.

Die-cast zinc products and zinc plated products where zinc has been plated on steel or the like are included among the zinc or zinc alloy products, and at least the surface of the product should comprise zinc or zinc alloy.

The water-soluble compounds which contain antimony, bismuth, tellurium or tin are soluble in water under acidic or alkaline conditions, and they include, for example, antimony pentachloride, antimony pentoxide, antimony sulphate, antimony tribromide, antimony trichloride, antimony trioxide, antimony trisulphide, antimony benzoate, antimony tartrate, bismuth chloride, bismuth citrate, bismuth fluoride, bismuth hydroxide, bismuth tri-iodide, bismuth sulphate, bismuth oxychloride, bismuth acetate, bismuth benzoate, bismuth tartrate, bismuth carbonate, bismuth nitrate, bismuth salicylate, bismuth trisulphide, potassium tellurate, potassium tellutite, potassium stannate and tin sulphate. The amounts compounded differ according to the type of water-soluble compound, but generally the amounts compounded are of the order of from 0.5 to 50 g/L, and preferably of the order of from 1 to 20 g/L.

The agents for the surface treatment of zinc or zinc alloy products of this invention include at least one of these water-soluble compounds which contain antimony, bismuth, tellurium or tin, but antimony or bismuth are especially desirable since they are reactive again on being wetted with water after a film has been formed on the surface of a zinc or zinc alloy product and a new film is formed so that the corrosion resistance life expectancy is prolonged. Furthermore, by using two, three or all four of antimony, bismuth, tellurium and tin conjointly the adhesion, hardness and smoothness of the film are improved and it is also possible to control the colour effectively. From these points of view the most ideal combinations in the case of conjoint use are those combinations of two or more including antimony and/or bismuth. In connection with the colour there is a tendency towards increased blackness, greyness, whiteness and whiteness as more antimony, bismuth, tellurium or tin, respectively, is compounded.

The inclusion in the agents for the surface treatment of zinc or zinc alloy products of this invention in addition to at least one of these water-soluble compounds which contains antimony, bismuth, tellurium or tin of a nickel salt and/or a manganese salt is ideal for reinforcing the corrosion resistance. The amount compounded is generally of the order of from 1 to 20 g/L, and preferably of the order of from 5 to 10 g/L.

Salts selected from among the sulphates, chlorides, nitrates and phosphates are preferred for the nickel salts and manganese salts. These nickel salts and manganese salts can reinforce the corrosion resistance and, for example, manganese sulphate is most desirable for improving the corrosion resistance by improving adhesion, and in the case of the nickel salts, and especially nickel sulphate, the conjoint use of the hypophosphite is especially desirable for improving the hardness in addition to the corrosion resistance. The amount of hypophosphite compounded is generally of the order of from 1 to 20 g/L and preferably of the order of from 5 to 10 g/L.

Furthermore, by including tannins such as tannic acid and the like and/or thioureas such as thiourea or salts thereof the dispersion properties are improved and the corrosion resistance is improved even more, and the gloss is increased and a beautiful colour can be obtained. The amounts in which these materials are compounded are generally of the order of from 5 to 50 g/L and preferably of the order of from 10 to 30 g/L.

Moreover, various other additives can be added to the agents for the surface treatment of zinc or zinc alloy products of this invention in accordance with the intended purpose. Examples include inorganic additives selected from among the inorganic acids, except for sulphuric acid and hydrochloric acid, and iodine compounds such as iodine and potassium iodide, and organic additives selected from among the amino acids, starch, cellulose, gelatin, rosin and poly(vinyl alcohol). The amounts compounded are generally of the order of from 0.5 to 10 g/L, and preferably of the order of from 1 to 5 g/L. By including these additives the film is made more dense, the hardness is improved and it is possible to prolong the life expectancy of the corrosion resistance.

The agents for the surface treatment of zinc or zinc alloy products of this invention may be used as acidic or alkaline baths. The reaction rate is greater on the acidic side and tends to be low on the alkaline side and so they are preferably used at a pH of from 4 to 5 to obtain the optimum reactivity, but they are not limited to this pH range.

Moreover, various additives other than those indicated above, such as dispersing agents, dispersion promoters and compounding ingredients for imparting an intended colour can be added appropriately to the agents for the surface treatment of zinc or zinc alloy products of this invention in accordance with the intended purpose.

When carrying out the surface treatment of a zinc or zinc alloy product using an agent for the surface treatment of zinc or zinc alloy products of this invention the zinc or zinc alloy product is immersed in an aqueous solution which contains this surface treatment agent and a corrosion resistant film of at least one water-soluble compound which contains antimony, bismuth, tellurium or tin is formed on the surface of the zinc or zinc alloy product. The thickness of this film can be determined appropriately according to the intended purposes but it is generally from 0.5 to 2 μm. At the time of the immersion treatment of the zinc or zinc alloy product the oxide which is attached to the surface has preferably been removed beforehand by the usual means such as de-greasing, acid washing, neutralization, etching and the like. The immersion treatment of the zinc or zinc alloy product is generally carried out at a temperature of from 15 to 40° C., and preferably of from 20 to 30° C., and for a period of about 5 minutes. For example, if a temperature exceeding 40° C. is used then the rate of formation of the film is increased and so more rigorous quality control is desirable. The immersion treated zinc or zinc alloy product is then washed and dried in the usual way. The colour of the film which is formed on the surface of the zinc or zinc alloy product in this way differs according to the components of the agent for surface treatment purposes.

In this invention the zinc or zinc alloy products which have been immersion treated in the way outlined above are preferably also immersed in an aqueous solution which contains a sealing treatment agent to seal the pinholes. The sealing treatment agent is preferably selected in accordance with the colour of the zinc or zinc alloy product, and examples include (yellow) boric acid, ammonium oxalate; (yellow-brown) chromic acid, citric acid, tartaric acid, phthalic acid, malic acid; (whitish-yellow) succinic acid and (greyish-yellow) maleic acid. The sealing treatment is preferably carried out by immersion in an aqueous solution which contains some 5 to 10 g/L of a sealing treatment agent as indicated above generally at a temperature of from 20 to 40° C. for a period of the order of from 1 to 5 minutes. Then the product is preferably washed in pure water at a temperature of from 50 to 60° C. and dried.

The invention is described in more detail below by means of illustrative examples, but the invention is not limited by these illustrative examples.

### EXAMPLE 1

A zinc-plated steel bolt (length about 70 mm) was immersed and treated for 2 minutes at 35° C. in an aqueous solution (pH 3 to 5) which contained 2 g/L of tin sulphate, 5 g/L of manganese sulphate, 2 g/L of iodine, 5 g/L of potassium iodide and 10 g/L of tannic acid and a green coloured film was obtained.

### EXAMPLE 2

A zinc-plated steel bolt (length about 70 mm) was immersed and treated for 2 minutes at 35° C. in an aqueous solution (pH 5 to 6) which contained 2 g/L of tin sulphate, 5 g/L of manganese sulphate, 1 g/L of selenous acid, 8 g/L of sulphuric acid and 10 g/L of tannic acid and a gold coloured film was obtained.

### EXAMPLE 3

A zinc-plated steel bolt (length about 70 mm) was immersed and treated for 2 minutes at 20° C. in an aqueous solution (pH about 5) which contained 2 g/L of tin sulphate, 25 g/L of nickel sulphate, 20 g/L of sodium hypophosphite, 30 g/L of ammonium sulphate, 15 g/L of boric acid and 15 g/L of glycerine and a bronze coloured film was obtained.

### EXAMPLE 4

A zinc-plated steel bolt (length about 70 mm) was immersed and treated for 2 minutes at 20° C. in an aqueous solution (pH 4 to 5) which contained 15 g/L of antimony tartrate, 25 g/L of manganese sulphate, 10 g/L of ammonium oxalate and 5 g/L of thiourea and a black coloured film was obtained.

### EXAMPLE 5

A zinc-plated steel bolt (length about 70 mm) was immersed and treated for 2 minutes at 20° C. in an aqueous solution (pH about 10) which contained 15 g/L of antimony tartrate, 25 g/L of manganese sulphate, 2 g/L of pyrophosphoric acid, 25 g/L of caustic soda, 5 g/L of thiourea and 5 g/L of potassium permanganate and a yellow coloured film was obtained.

### EXAMPLE 6

A zinc-plated steel bolt (length about 70 mm) was immersed and treated for 2 minutes at 25° C. in an aqueous solution (pH about 10) which contained 3 g/L of bismuth chloride, 25 g/L of manganese sulphate, 25 g/L of caustic soda, 5 g/L of thiourea and 2 g/L of potassium permanganate and a brown coloured film was obtained.

### EXAMPLE 7

A zinc-plated steel bolt (length about 70 mm) was immersed and treated for 3 minutes at 25° C. in an aqueous solution (pH about 11) which contained 6 g/L of antimony dioxide, 25 g/L of manganese sulphate, 30 g/L of caustic soda, 5 g/L of thiourea and 5 g/L of potassium perchlorate and a coffee coloured film was obtained.

### EXAMPLE 8

A zinc-plated steel bolt (length about 70 mm) was immersed and treated for 2 minutes at 40° C. in an aqueous solution (pH about 11) which contained 5 g/L of bismuth nitrate, 25 g/L of manganese sulphate, 30 g/L of caustic soda, 40 g/L of zinc nitrate and 50 g/L of diethylene glycol and a grey coloured film was obtained.

### EXAMPLE 9

A zinc-plated steel bolt (length about 70 mm) was immersed and treated for 2 minutes at 20° C. in an aqueous solution (pH 4 to 5) which contained 15 g/L of potassium tellurate, 25 g/L of manganese sulphate, 10 g/L of ammonium oxalate and 5 g/L of thiourea and a black coloured film was obtained.

### EXAMPLE 10

A zinc-plated steel bolt (length about 70 mm) was immersed and treated for 2 minutes at 20° C. in an aqueous solution (pH 4 to 5) which contained 15 g/L of antimony tartrate, 5 g/L of bismuth chloride, 25 g/L of manganese sulphate, 10 g/L of ammonium oxalate and 5 g/L of thiourea and a black coloured film was obtained.

Good corrosion resistance was observed on spraying salt water for 72 hours onto the immersion treated bolts obtained in Examples 1 to 10 described above and testing the corrosion resistance in respect of salt water.

The immersion treated bolts obtained in Examples 1 to 10 described above were immersed generally at about 30° C. for from 2 to 3 minutes in an aqueous solution which contained from 5 to 10 g/L of a sealing treatment agent as indicated below according to the colour, and then they were washed in pure water at from 50 to 60° C. and dried and a further improvement in corrosion resistance was observed.

(Green) Iodine; (Gold) Selenous acid; (Bronze) Boric acid; (Black) Ammonium oxalate; (Yellow) Picric acid; (Brown) Potassium permanganate; (Coffee coloured) Potassium perchlorate; (Grey) Maleic acid.

By means of the present invention it is possible to provide an agent for surface treatment which can impart excellent corrosion resistance to zinc or zinc alloy

We claim:

1. An agent for the surface treatment of a zinc or zinc alloy substrate, comprising a water-soluble compound of antimony, bismuth, tellurium, tin, or a combination thereof.

2. The agent of claim 1, further comprising a nickel salt, a manganese salt, or a combination thereof.

3. The agent of claim 2, further comprising tannins, thioureas, or a combination thereof.

4. The agent of claim 2, wherein the nickel salt, manganese salt, or combination thereof is a sulphate, chloride, nitrate, phosphate, or combination thereof.

5. The agent of claim 1, further comprising inorganic additives selected from inorganic acids, iodine compounds, or a combination thereof.

6. The agent of claim 1, further comprising organic additives selected from amino acids, starch, cellulose, gelatin, rosin, poly(vinyl alcohol), or a combination thereof.

7. A method for the surface treatment of a zinc or zinc alloy substrate, comprising the step of immersing the zinc or zinc alloy substrate in a water-soluble compound of antimony, bismuth, tellurium, tin, or a combination thereof.

8. The method of claim 7, further comprising adding a nickel salt, a manganese salt, or a combination thereof.

9. The method of claim 8, further comprising adding tannins, thioureas, or a combination thereof.

10. The method of claim 9, wherein the nickel salt, manganese salt, or combination thereof is a sulphate, chloride, nitrate, phosphate, or combination thereof.

11. The method of claim 7, further comprising adding inorganic additives selected from inorganic acids, iodine compounds, or a combination thereof.

12. The method of claim 7, further comprising organic additives selected from amino acids, starch, cellulose, gelatin, rosin, poly(vinyl alcohol) or a combination thereof.

13. The method of claim 7, further comprising the step of immersing the zinc or zinc alloy substrate in an aqueous solution of a sealing treatment agent.

14. The method of claim 13, wherein the sealing treatment agent is selected according to the color of the zinc or zinc alloy product.

15. The method of claim 14, wherein the sealing treatment agent is boric acid, ammonium oxalate, chromic acid, citric acid, tartaric acid, phthalic acid, malic acid, succinic acid, maleic acid or combinations thereof.

16. The method of claim 15, wherein the sealing treatment agent is provided at a concentration of between about 5 to about 10 g/L.

17. The method of claim 15, wherein the sealing treatment agent is provided at a temperature of between about 20° C. and about 40° C.

18. The method of claim 15, wherein the immersion is conducted for between about 1 and about 5 minutes.
